(19) United States
(12) Patent Application Publication
(10) Pub. No.: US 2006/0076939 A1
(43) Pub. Date: Apr. 13, 2006

(54) Electrical converter for converting electrical power

(75) Inventor: Jan Reinder De Boer, Drachten (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/542,907

(22) PCT Filed: Jan. 14, 2004
(86) PCT No.: PCT/IB04/50023

§ 371 Date: Jul. 20, 2005

(30) Foreign Application Priority Data
Jan. 23, 2003 (EP) 03100131.6

(51) Int. Cl. G05F 1/40

(52) U.S. Cl. 323/282

(57) ABSTRACT

An electrical converter (1) comprising a converter input (IN1, IN2) for receiving electrical power; a converter output (OUT1, OUT2) for releasing electrical power; an electrical energy storage device (2) having a storage input connected to a converter input (IN1, IN2) and having a storage output connected to a converter output (OUT1, OUT2). During a primary stroke period (tₚᵣᵢₘ) electrical energy is stored from the received electrical power, and during a secondary stroke period (t_{sec}) electrical energy is released to the converter output (OUT1, OUT2). The electrical converter (1) has a control device (4) comprising: a current sensing device (5) for sensing the amount of current flowing to the electrical energy storage device (2); a first time control device (44) communicatively connected to the current sensing device for controlling the duration of at least one of said stroke periods such that the current flowing to the electrical energy storage device (2) during the primary and secondary stroke is substantially equal to or lower than a predetermined maximum current; and a second time control device (41-43) for controlling the duration of an off-time period (t_{off}) in which the electrical energy storage device (2) releases substantially no electrical energy, such that a time average of the current flowing to the electrical energy storage device (2) is equal to a predetermined value, which time average is the average over a switching period comprising the primary stroke period (tₚᵣᵢₘₑ), the secondary stroke period (t_{sec}), and the off-time period (t_{off}).

### FIELD AND BACKGROUND OF THE INVENTION

The invention relates to an electrical converter for converting electrical power.

In the art of electronic power supplies, electrical converters are generally known which store and release electrical energy from supplied electrical power. Such converters usually operate by using an electronic switch to pass a current through an inductor and then interrupt the current periodically to produce a “flyback” voltage for transfer through a diode to a capacitive load. These converters are used, for example, in battery powered equipment, such as portable communication receivers. In such equipment, the battery usually has to be connected to an AC power supply of 110 V or 220 V whereas the battery has to be charged with a 1.5 V DC-current.

United States patent publication U.S. Pat. No. 5,864,225 discloses a DC-DC dual adjustable voltage regulator. The adjustable voltage regulator comprises a field effect transistor operated as a switch connected in series with a diode. A contact of an inductor is connected to the node between the field effect transistor and the diode. Another contact of the inductor is connected in series with a supply voltage output via a resistor. The gate of the field effect transistor is connected to a switching regulator circuit which controls the voltage of the gate and thus the switching of the field effect transistor. Thus, the switching regulator circuit also controls the storing and releasing of energy in the adjustable voltage regulator. The switching regulator circuit has a fixed on-time, variable off-time circuit which controls the switching of the field effect transistor via a buffer circuit. The off-time of the fixed on-time, variable off-time circuit is controlled via a feedback control circuit which controls an oscillator circuit in the fixed on-time variable off-time circuit based on both the output load current and the voltage at the outputs of the adjustable voltage regulator circuit. Hence, the on-time of the adjustable voltage regulator circuit is fixed, while the off-time is varied in dependence on the output load current and output voltage. The operation of the adjustable voltage regulator circuit thus depends on the output load current and output voltage.

A disadvantage of the circuit known from said US patent publication is that the operation of the adjustable voltage regulator circuit depends on the load connected to the output because the output load current and the output voltage are used in the feedback to determine the variable off-time. A further disadvantage is that this known circuit requires a complex feedback circuit since both the output load current and the output voltage are fed back.

### SUMMARY OF THE INVENTION

It is a general object of the invention to provide an improved electrical converter and more specifically an electrical converter which outputs a current which is independent of the output voltage of the converter. The invention provides an electrical converter according to claim 1 for this purpose.

The average current during the primary stroke period and the secondary stroke period is determined because the first time control device limits the current during the primary stroke period and the secondary stroke period to be equal to or below the predetermined maximum current. The second time control device controls the duration of the off-time period, and thus the average current during a switching period is determined. Thus, the time control devices, control of the periods is based only on the current flowing through the electrical energy storage device. Hence, the average converter current is not dependent on the output voltage of the converter.

The invention further provides an electrical appliance according to claim 11. In such an appliance the average converter current is not dependent on the output voltage of the converter device.

Specific embodiments of the invention are set forth in the dependent claims. Further details, aspects and embodiments of the invention will be described, by way of example only, with reference to the Figures in the attached drawings.

### BRIEF DESCRIPTION OF THE DRAWINGS

FIG. 1 schematically shows a circuit diagram of an example of an electrical converter according to the invention.

FIGS. 2A-B schematically show a graph of currents and voltages in different parts of the converter according to the invention of FIG. 1 as a function of time.

FIG. 3 shows a circuit diagram of an example of a switch control device suitable for the example of an electrical converter according to the invention of FIG. 1.

FIGS. 4-6 schematically show circuit diagrams of examples of voltage to current converters suitable for the example of a switch control device of FIG. 3.

FIGS. 7 schematically shows a circuit diagram of another example of an electrical converter according to the invention.

FIG. 8 shows an example of an electrical appliance comprising an electrical converter according to the invention.

### DETAILED DESCRIPTION

The example of an electrical converter 1 according to the invention shown in FIG. 1 is a Discontinuous Current Mode (DCM) converter. DCM converters are generally known in the art. The converter 1 is a down-converter with converter inputs IN1,IN2 for receiving electrical power, such as a DC voltage, and converter outputs OUT1,OUT2 for outputting converted electrical power, for example a DC current or a DC voltage. In this example, the converter outputs OUT1,OUT2 are current outputs. The converter outputs OUT1,OUT2 are connected to a battery 7 which operates at a voltage different from the voltage applied to the converter inputs IN1,IN2. However, other types of devices may likewise be connected to the converter outputs instead of the battery 7.

The converter 1 has an electrical energy storage device 2 for alternately storing and releasing electrical energy from the received electrical power. In this example, the electrical energy storage device is an inductor 2, which can store electrical energy in an electromagnetic field and release electrical energy by reducing the energy in the electromagnetic field.

In FIG. 1, the inductor 2 is connected in series with a resistor 5 and a switch 3 to the input IN1. A one-direction conducting device, e.g. a diode 6, connects the second input IN2 to the inductor 2, at the node 32 between the switch 3 and the inductor 2. The diode 6 has a forward direction from the input IN2 to the inductor 2 and a reverse direction from the inductor 2 to the input IN2. Thus, a current can flow through the diode 6 in the forward direction from the input node IN2 through the inductor 2 to the output node OUT1 and substantially no current can flow in the reverse direction towards the input node IN2 or the output node OUT2. Other types of one-direction conducting devices may likewise be used instead of a diode. For example, a synchronous rectifier field effect transistor may be used which is opened and closed in response to the direction of the current, or other devices.

The switch 3 has a first switch contact electrically connected to the converter input IN1, in this example via the resistor 5. The switch 3 further has a second switch contact which is electrically connected to the electrical energy storage device, e.g. the inductor 2. The first switch contact is electrically connected to the second switch contact in a conducting state of the switch 3. The switch is said to be closed in this conducting state. Thus the switch 3 enables electrical contact between the storage input and the converter inputs IN1,IN2 in the conducting state. In this conducting state, a current can flow from the input node IN1 to the output node OUT1 via the resistor 5, the switch 3, and the inductor 2, and electrical energy is stored in the inductor 2 in this state. In a non-conducting state of the switch 3, the first switch contact is electrically disconnected from the second switch contact. The switch is said to be open in this non-conducting state. Thus, in the non-conducting state, the electrical contract between the inductor 2 and the converter input IN1 is interrupted.

In the non-conducting state, substantially no current flows from the input node IN1. However, in the non-conducting state a current can flow from the input node IN2 to the output node OUT1 via the diode 6 and the inductor 2, and electrical energy can be released by the inductor 2 towards the output OUT1. In use, the switch 3 is switched from the conducting state to the non-conducting state and vice versa by a switch control device 4, and thus energy is alternately stored in the inductor and released. The average current and/or voltage of the electrical power at the converter outputs can be controlled thereby, so that the power can be converted.

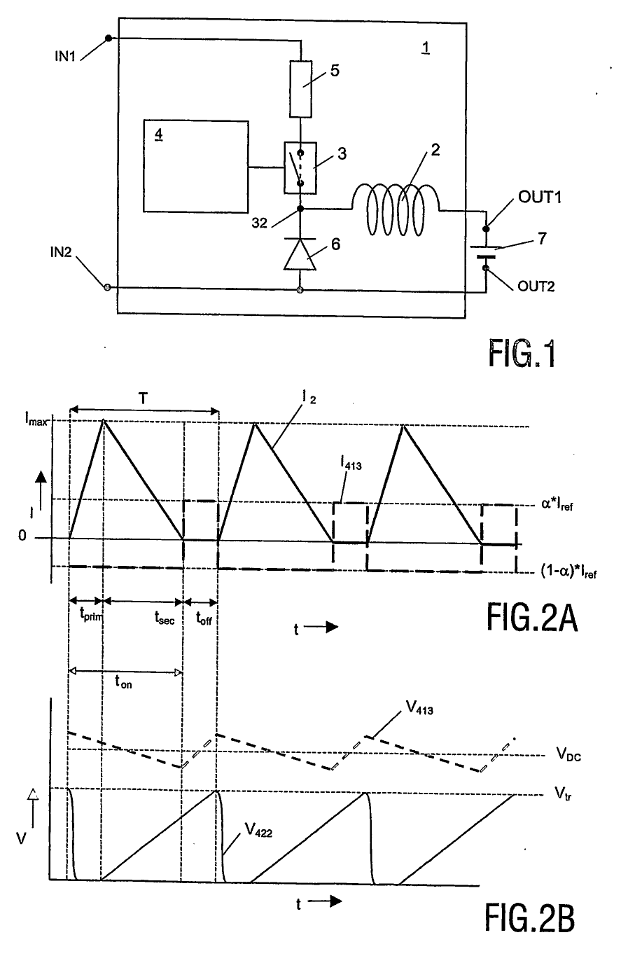

In FIG. 2A successive stages of the process of storing and releasing energy are illustrated by the solid line I₂ which represents the amount of current flowing from the inductor 2 to the output OUT1, as a function of time t. As shown in FIG. 2A, if the switch 3 is in the conducting state, current flows from the input IN1 to the output OUT1 through the inductor 2, and energy is stored in the inductor during a time called the primary stroke period tₚᵣᵢₘ. The more energy is stored in the electro-magnetic field of the inductor, the less power will be taken from the current and hence the more current will flow through the inductor. In the primary stroke, energy is released by the inductor 2 as well via the current to the converter output OUT1; however, as a net result the energy stored in the inductor 2 increases during the primary stroke tₚᵣᵢₘ.

At a certain moment the switch 3 is switched to the non-conducting state. As a result, no power is supplied to the inductor 2 anymore, and energy is released from the inductor 2 as a current during a time period called the secondary stroke t_{sec}. The primary stroke tₚᵣᵢₘ and the secondary stroke t_{sec} together are also referred to as the on-time tₒₙ of the converter 1. In the example of FIG. 1, the control device 4 switches the switch 3 to the non-conducting state when the current through the inductor 2 has reached a predetermined maximum. The predetermined maximum may be any maximum suitable for the specific implementation and may have a constant value or have a variable value, e.g. be predetermined by some algorithm. Likewise, the predetermined maximum may be fixed or be adjustable. To compensate for delays in the electrical converter, the control device 4 may start switching the switch 3 before the current actually reaches the predetermined maximum, for example by calculating an expected moment at which the current through the inductor will reach the predetermined maximum and switching the switch 3 such that at the expected moment the switch 3 is non-conducting.

After the inductor 2 has released substantially all of the stored energy, substantially no current will flow from the inductor 2 to the output OUT1. This interval in which substantially no current flows following the secondary stroke is called the off-time t_{off}. In the off-time t_{off}, the switch 3 is still in the non-conducting state. The primary stroke tₚᵣᵢₘ, secondary stroke t_{sec}, and off-time t_{off} together are called a conversion period T, which is also referred to as a switching period T. FIG. 2A shows three conversion periods. After the off-time t_{off}, the switch 3 is to be turned back to the conducting state and the cycle of storing and releasing energy can be performed again. In the example of FIG. 1, the off-time t_{off} is ended when the average current flowing through the inductor has reached a predetermined value. The average is taken over one conversion period T.

The average current through the inductor 2 during the primary and secondary strokes is determined by the maximum current. In general, the current increases exponentially during the primary stroke and decreases exponentially during the secondary stroke because of the resistor 5 and the inductor 2. In this example the resistor 5 has a small resistance and the current has an approximately linear behavior as a function of time. The average current during the on time tₒₙ is thus approximately equal to half the predetermined maximum current. Thus, by varying the off-time t_{off}, the average current of a conversion period can be controlled. In a mathematical way:
I_{average}=Iₘₐₓ*(tₚᵣᵢₘ+t_{sec})/(2>T) (1)
In this equation (1) I_{average} represents the average current and Iₘₐₓ the predetermined maximum current. Thus, by varying the conversion period T through control of the duration of the off-time t_{off}, the average current during a conversion period can be controlled. Hence, when the predetermined value is a factor alpha times the maximum current Iₘₐₓ, the off-time t_{off} is controlled to be:
t_{off}=(1−alpha)(tₚᵣᵢₘ+t_{sec})/alpha (2)

It should be noted that in this example the current through the inductor 2 during the primary stroke and the secondary stroke is substantially linear as a function of the on time. However, in a converter according to the invention the current may behave differently, e.g. be a quadratic or other function of time.

In the example of FIG. 1, the resistor 5 is a current sensing device which senses the current flowing from the input node IN1 through the inductor 2 to the output OUT1, because the voltage V₅ across the resistor 5 is equal to this current times the resistance of the resistor 5. In general this current has a maximum value in the range of 1-10 amperes, and the resistor 5 may have any resistance suitable for the specific implementation. To reduce power losses in the converter, the resistance should be as low as possible and be in the range of, for example, 10-100 mΩ. Such a resistance results in a voltage drop across the resistor 5 in the range of 0.01 to 1 V, which can be easily measured. However, the current flowing through the inductor 2, the resistance of the resistor 5, and the voltage drop across the resistor 5 may likewise have any other value suitable for the specific implementation.

In the example of FIG. 1, the current sensing device and the switch 3 are implemented as separate devices, i.e. the resistor 5 and the switch 3. However, the current sensing device and the switch 3 may alternatively be a single device such, as for example, a sensing field effect transistor also known in the art as a sensefet. In general, a sensefet can sense a current flowing through the source and drain and be switched to a conducting state and a non-conducting state. Thus, a sensfet connected between the input node IN1 and the inductor 2 may perform the current sensing function and as well as a switch function.

In the example of FIG. 1, the current sensing device, e.g. the resistor 5, further limits the current flowing to the inductor 2 to a maximum. The resistor 5 thus acts as a limiter in the conducting state of the switch 3. However, when the switch 3 is in the non-conducting state, e.g. during the secondary stroke and in the off-time, the resistor 5 does not limit the current since no current flows through the resistor 5. Hence, in the secondary stroke and the off-time the resistor 5 does not dissipate energy released from the inductor 2 to the converter output OUT1. The maximum current through the resistor 5 may, for example, be equal to the predetermined maximum current Iₘₐₓ which triggers the switching of the switch 3 and thus the end of the primary stroke tₚᵣᵢₘ and the start of the secondary stroke t_{sec}.

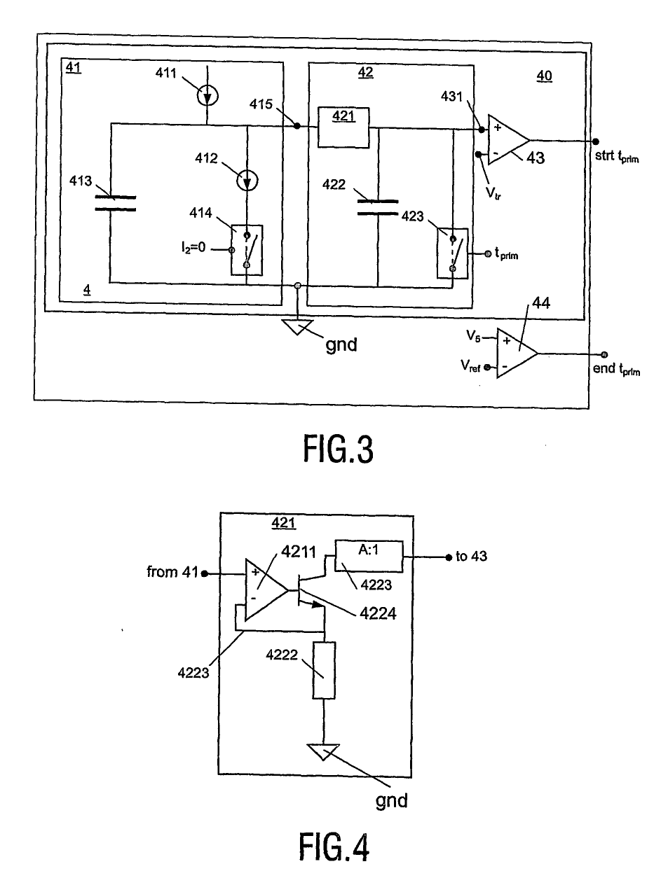

As shown in FIG. 2A, the current flowing through the inductor 2 increases during the storing of energy in the electro-magnetic field, e.g. during the primary stroke tₚᵣᵢₘ, as more energy is stored in the inductor 2. The saturation current is the current flowing, through the inductor 2 when no more further energy can be stored in the inductor 2. The maximum current allowed by the resistor 5 or the control device 4 may be set, for example, to be lower than or equal to the saturation current of the inductor 2 by setting the predetermined maximum current Iₘₐₓ lower than the saturation current and thereby switching the switch 3 automatically before the inductor 2 is saturated. Thereby the inductor 2 is automatically protected against saturation. As will be shown in more detail in FIGS. 3 and 4, the desired average current is obtained automatically via the control device 4 in the example of FIG. 1. In this example the control device 4 is a switch control device which switches the switch 3 such that, given a suitable on-time and off-time t_{off} of the converter 1, the average current equals the predetermined value. In general, the switch control device 4 may be implemented in any manner suitable for the specific implementation to control the state of an electrical converter device according to the invention. FIG. 3 shows an example of a switch control device 4 for automatic switching which may be used in the example of an electrical converter 1 of FIG. 1. It should be noted that the switch 3 may likewise be switched in a different manner. The control device 4 may comprise, for example, a suitably programmed microprocessor which measures the maximum current during the primary stroke and the secondary stroke, calculates an off-time period suitable to achieve the predetermined average current, and switches the switch 3 accordingly or otherwise.

The switch control device 4 in FIG. 3 opens the switch 3 after a comparison of a first signal V₅ with a reference signal V_{ref} has yielded a result which satisfies an opening criterion. In this example, the switch control device 4 has a first time control device comprising a comparator 44 which can measure the current through the resistor 5 and compare the measured current with a reference value, in this example by measuring the voltage V₅ across the resistor 5 and comparing the voltage V₅ with a reference voltage V_{ref}. When the voltage V₅ comes above the reference voltage V_{ref}, the control device 4 opens switch 3 and the primary stroke tₚᵣᵢₘ is ended. Thus, the peak current Iₚₑₐₖ through the inductor 2 and the desired average amount of current can easily be adjusted by changing the criterion which causes the first time control device to open the switch 3, for example by adapting the reference voltage V_{ref}.

The switch control device 4 compares a second signal with a reference signal Vₜᵣ and closes the switch 3 if the result of the comparison satisfies a closing criterion. For this purpose, the switch control device 4 has a second time control device 40 with a second comparator device 43 which compares the voltage V₄₃₁ at node 431 with a trigger voltage Vₜᵣ. When the voltage V₄₃₁ comes above the trigger voltage Vₜᵣ, the switch control device 4 closes switch 3 and thus the primary stroke is started. Thus, the average current I_{average} through the inductor 2 can easily be adjusted. The average current I_{average} may be changed, for example, via the manner in which the second signal is generated, for example by changing the factor alpha in the first on-off period control device 41, as will be explained below in more detail, or in some other manner.

In the example of FIG. 3, the switch control device 4 has a first on-off period control device 41. The first on-off period control device 41 has a first capacitor, denoted integrating capacitor 413, a first current source 412, and a switch 414 which are connected to each other and form an interruptable current loop. The switch 414 acts as an interrupter and can open and close the interruptable current loop. At one node of the integrating capacitor 413, the interruptable current loop is connected to a second current source 411. Thus, when the switch 414 holds the loop open, no current can flow through the loop and current can only flow from the second current source 411 to the node of the integrating capacitor 413 connected to the second current source 411. In the open loop state, the integrating capacitor 413 is charged and hence the voltage across the integrating capacitor 413 is increased. When the loop is closed by the switch 414, current can flow through the loop. Thus, the integrating capacitor 413 will discharge and the voltage across the integrating capacitor 413 will be decreased.

In the example of FIG. 3, the loop of the first on-off period control device 41 is closed during the primary and secondary stroke and the loop is open during the off-time t_{off}. Thus, during the primary stroke tₚᵣᵢₘ and the secondary stroke t_{sec}, the switch 414 is closed or in the conducting state and in the off-time t_{off} the switch 414 is open or in the non-conducting state. Hence, the voltage V₄₁₃ decreases during the primary stroke tₚᵣᵢₘ and the secondary stroke t_{sec} and increases during the off-time t_{off}. The current to the integrating capacitor 413 is depicted in FIG. 2A with dashed line I₄₁₃. The voltage across the integrating capacitor 413 is depicted in FIG. 2B as a function of time with dashed line V₄₁₃. As shown in FIG. 2B, the voltage across the integrating capacitor 413 alternately increases and decreases around a DC offset level V_{DC}.

In the example shown, the first current source 412 delivers a current Iref in the direction indicated and the second current source 411 is set to deliver a current Iref*alpha, alpha being a factor smaller than 1, in the direction indicated with the arrow. Hence, in the closed loop state, the voltage V₄₁₃ across the integrating capacitor 413 can be described asV₄₁₃=V₀−((1−alpha)*Iref*t_{closed})/C₄₁₃, with C₄₁₃ representing the capacitance of the integrating capacitor 413; V₀ the voltage across the integrating capacitor 413 at the moment the loop was closed and t_{closed} the time lapsed after closing of the loop.

When the loop is opened, the voltage across the integrating capacitor 413 can be described as V₄₁₃=V₀+(alpha*I_{ref}*tₒₚₑₙ)/C₄₁₃ with tₒₚₑₙ representing the time passed after opening of the loop with the switch 414 and V₀ the voltage across the integrating capacitor 413 at the moment the loop was opened. The open time tₒₚₑₙ is equal to the off-time of the converter 1 and the closed time t_{closed} is equal to the on-time tₒₙ of the converter 1. Thus, if the voltage across the integrating capacitor 413 is used as the second signal V₄₃₁ and the trigger voltage Vₜᵣ is set to V₀, the switch 3 is closed, i.e. the primary stroke tₚᵣᵢₘ is started when the off-time has equalled (1-alpha)(tₚᵣᵢₘ+t_{sec})/alpha and the average current has the predetermined value.

The average current of a converter according to the invention with a control device comprising a first on-off period control device 41 as depicted in FIG. 3 can be easily adjusted by changing the ratio alpha of the currents of the current sources 411,412. For example, the average current from the second current source 411 to the integrating capacitor 413 (and thus the constant alpha) can be controlled by alternately enabling and disabling the current flow from the second current source 411. The average current from the second current source 411 to the integrating capacitor 413 is then equal to alpha times Iref times the duty cycle of the enabling and disabling. The current from the second current source 411 will then have a frequency of the enabling and disabling. However, this frequency component is eliminated by the integrating properties of the integrating capacitor 413. With an alternate enabling and disabling of the current from the second current source 411 to the integrating capacitor 413, the average converter current is linearly dependent on the duty cycle, and thus a linear control of the average current is obtained through a control of the duty cycle. The enabling and disabling may be implemented, for example, by providing a switch between the second current source 411 and the integrating capacitor 413 of the switch and alternately opening and closing the switch by suitable switch control means.

The current of the converter may likewise be controlled via the voltage across the integrating capacitor 413. For example, a field effect transistor may be connected by its source and drain to the respective electrodes of the integrating capacitor 413. By applying a suitable voltage to the gate of the field effect transistor, a current can be made to flow via the field effect transistors between the electrodes of the integrating capacitor 413, whereby the integrating capacitor 413 is discharged and the voltage across the integrating capacitor 413 changed.

The first on-off period control device 41 and optionally the second on-off period control device 42 are simple and use few components. Furthermore, the first on-time control device 41 forms a first order integrating control loop with the on-time tₒₙ as its input and the off-time t_{off} as its output. Thus, the switch control device 4 does not use a feedback loop and hence does not have stability problems caused by the feedback.

In the example of FIG. 3, the integrating capacitor 413 is connected to a voltage input 415 of a voltage to current converter 421 of a second on-off period control device 42. The voltage to current converter 421 outputs a current I which is a function of the voltage V presented at its input, e.g. in a mathematical notation I=f(V). FIGS. 4-6 show examples of the voltage to current converter 421. In the example of FIG. 3, the voltage to current converter 421 is supposed to be implemented as is depicted in FIG. 4.

The current output of the voltage to current converter 421 is connected to a contact of a second capacitor 422. The second capacitor 422 is charged thereby with the current from the current output, in response to the voltage V₄₁₃ across the integrating capacitor 413. Thus the amount of current fed to the second capacitor 422 and hence the voltage V₄₂₂ across the contacts of the second capacitor 422 depends on the voltage V₄₁₃ across the integrating capacitor 413 and hence on the factor alpha. The off-time accordingly depends on the factor alpha as well. Furthermore, the converter can be soft started via the voltage to current converter 421 and the integrating capacitor 413. Initially, only a low voltage will be present across the integrating capacitor 413, which voltage will increase after some switching operations. After several periods, the voltage across the integrating capacitor 413 will have a DC-offset V_{DC} as shown in FIG. 2B. When the voltage across the integrating capacitor 413 is low, only a small current will be outputted by the voltage to current converter 421 and hence, the second capacitor 422 will be charged relatively slowly and it will take a relative long time until the voltage across the second capacitor 422 reaches the trigger voltage Vₜᵣ. Thus, using a suitable capacitance for the integrating capacitor 413, the time for charging the second capacitor 422 to V_{ref} will be relatively long, and the amount of power provided at the converter output OUT1 can be initially set to be low and then be increased over time. The time for charging and discharging can also be adjusted via the constant alpha of the second current source 411.

The second on-off period control device 42 is connected to an input of the second comparator 43. In FIG. 2B, the line V₄₂₂ represents the voltage at the positive input 431 as a function of time. The trigger voltage Vₜᵣ is indicated with the dotted line Vₜᵣ. The second capacitor 422 is connected to a switch 423 and forms a current loop with this switch 423. The switch 423 can open and close the loop. At one node of the second capacitor 423, the loop is connected to the positive input 431 of the second comparator 43. Thus the voltage V₄₂₂ across the second capacitor 422 is transmitted to the second comparator 43. The switch 423 is switched independence on the current flowing through the inductor 2 of the converter of FIG. 1 and is opened the moment the current through the inductor 2 reaches its maximum value, as is shown with the dashed line Iₘₐₓ in FIG. 2A.

In the example of FIG. 3, the switch 423 is closed, i.e. the switch 423 is switched to the conducting state when the primary stroke tₚᵣᵢₘ is started. Thus at the start of the primary stroke tₚᵣᵢₘ, the second capacitor 422 is short-circuited and discharged, as is depicted in FIG. 2B with the solid line V₄₂₂. A too short time period of the primary stroke tₚᵣᵢₘ is prevented thereby, which is especially useful if the amount of output current at the converter output OUT1,OUT2 has to be controlled with high precision.

In the example of FIG. 3, the switch 423 is kept closed during the entire primary stroke tₚᵣᵢₘ; however, it is likewise possible to close the switch 423 for a short period only at the start of the primary stroke tₚᵣᵢₘ, e.g. in a pulsed manner. It is also possible to keep switch 423 closed in dependence on the voltage across the second capacitor 422, e.g. until the voltage across the second capacitor 422 is substantially zero.

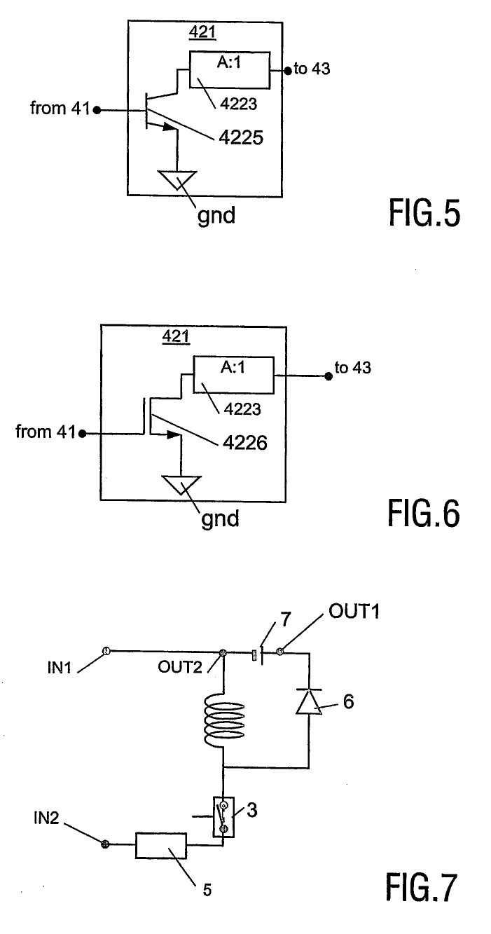

The voltage to current converter 421 may be implemented, for example, as shown in FIG. 4, but may alternatively be implemented in a different manner, for example as depicted in FIGS. 5 and 6 or otherwise. In general, the voltage to current converter 421 may be implemented in any manner suitable for the specific application.

In the voltage to current converter 421 of FIG. 4, the output of an amplifier 4211 is connected to the base of a bipolar transistor 4224. The inverting input of the amplifier 4211 is connected to the emitter of the bipolar transistor 4224. The emitter is further connected to ground gnd via a resistor 4222. The collector of the bipolar transistor 4224 is connected to an input of a current mirror 4223 which at an output outputs a current which is proportional to the current drawn from the current mirror 4223 by the bipolar transistor 4224, and these currents have a ratio of A:1. Thus, the current at the output of the current mirror 4223 is linearly dependent on the voltage applied to the non-inverting input of the amplifier 4211.

In the example of FIG. 5, a bipolar transistor 4225 is connected with its base to the first time control device. The collector of the bipolar transistor is connected to a current mirror and the emitter to ground. Thus, the current at the output of the current mirror 4223 is exponentially dependent on the voltage applied to the base of the transistor.

In FIG. 6, the gate of a field effect transistor 4226 is connected to the first time control device 41. The source is connected to ground and the drain to the current mirror. Thus, the current at the output of the current mirror 4223 is more or less quadratically dependent on the control voltage applied to the gate of the field effect transistor 4226.

The switching of a converter according to the invention depends only on the current flowing through the electrical energy storage device. Hence, the switching is substantially independent of the input voltage or the output voltage of the converter, as well as of the inductance of the inductor 2. The output current of a converter according to the invention is therefore also independent of the input voltage or the output voltage of the converter, as well as of the inductance of the inductor 2.

The example of a switch control device 4 of FIGS. 3 and 4 has an inherent stability because no feedback is present and the off-time is controlled in a feedforward manner. Hence no additional measures are required to stabilize an electrical converter according to the invention. Furthermore, if a second on-off period control device 42 is used, the capacitor 413 in the first on-off period control device 41 is not critical to the functioning of an electrical converter according to the invention. As long as the voltage across the integrating capacitor 413 is not clipped, the desired average current will be obtained via the current balance in the on-off period control devices 41,42. Furthermore, subharmonic changes, for example caused by irregular changes in t_{off}, do not significantly disturb the average current because of the current balance. However, in an electrical converter according to the invention, the switch control device 4 may likewise have only a first on-off period control device and no second on-off period control device.

FIG. 7 shows another example of an electrical converter circuit according to the invention. In the example of FIG. 7, substantially no current flows through the battery during the primary stroke, because the inductor is connected in a loop with the diode and battery, while the node between inductor and diode is connected via a switch to an input, and the node between diode and battery is connected to the other input. In the example of FIG. 7, the switch may be controlled by a control circuit similar to the example of FIG. 3. However, the average current flowing through the inductor 2 to the battery during one conversion period is equal to (½*Iₚₑₐₖ*t_{sec})/T instead of ½*Iₘₐₓ*(tₚᵣᵢₘ+_{tsec})/T, and by switching, for example, switch 413 at t_{sec} instead of tₒₙ, the average current can be controlled via the off-time t_{off} as well.

The converter outputs OUT1,OUT2 of the examples of an electrical converter according to the invention of FIGS. 1 and 6 are current outputs. However, an electrical converter according to the invention may likewise have converter outputs which are voltage outputs. For example, the converter outputs OUT1,OUT2 of the example of an electrical converter 1 in FIG. 1 may be connected to an output voltage control circuit which senses the output voltage at the converter outputs and adjusts the current outputted at the converter outputs so as to maintain a specific output voltage. The output voltage control circuit may adjust, for example, the constant alpha of the second current source 411 in the switch control device 4 of FIG. 1 via suitable means, such as the duty cycle of a switch as was explained in more detail above.

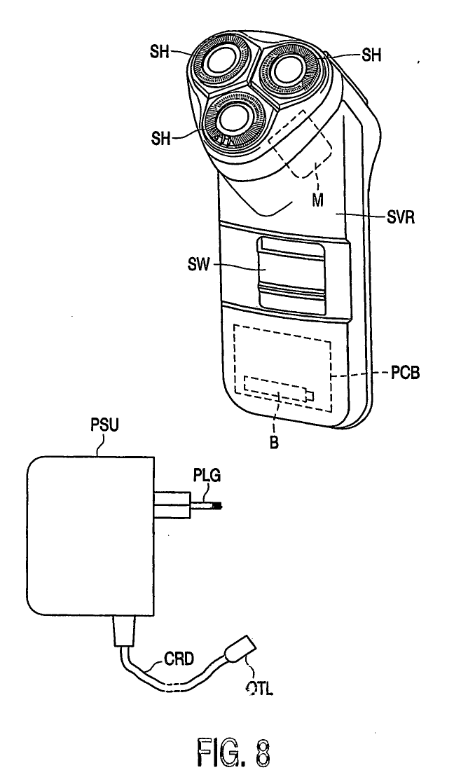

The electrical converter in accordance with the invention is suitable for a variety of apparatuses with rechargeable batteries that are charged from the mains voltage, in particular rechargeable electric shavers and toothbrushes. FIG. 8 shows by way of example a shaver SVR with a motor M which drives shaving heads SH. The motor M is engaged with a switch SW, which connects the motor M to the rechargeable battery B, which together with the other electronic components, for example those of the circuits shown in the FIGS. 1 and 3, is accommodated on a printed circuit board PCB in the shaver SVR. FIG. 8 further shows a power supply unit PSU, which may contain parts of the electrical converter device. The power supply unit PSU has an integrated mains plug PLG for connection to the mains voltage and a connecting cord CRD, which can be coupled to an inlet socket (not shown) of the shaver SVR by means of an outlet OTL.

1. An electrical converter (1) comprising:
at least one converter input (IN1,IN2) for receiving electrical power;
at least one converter output (OUT1,OUT2) for releasing electrical power;
an electrical energy storage device (2) having a storage input connected to at least one of the converter inputs (IN1,IN2) and having a storage output connected to at least one of the converter outputs (OUT1,OUT2), for storing electrical energy from the received electrical power during a primary stroke period (tₚᵣᵢₘ) and for releasing electrical energy to the converter output (OUT1,OUT2) during a secondary stroke period (t_{sec}),
said electrical converter (1) further comprising a control device (4) comprising:
a current sensor (5) for sensing the amount of current flowing to the electrical energy storage device (2);
a first time control device (44) communicatively connected to the current sensing device for controlling the duration of at least one of said stroke periods such that the current flowing to the electrical energy storage device (2) during said stroke periods is substantially equal to or lower than a predetermined maximum current (Iₘₐₓ); and
a second time control device (40) for controlling the duration of an off-time period (t_{off}) in which the electrical energy storage device (2) releases substantially no electrical energy, such that a time average of the current flowing to the electrical energy storage device (2) is equal to a predetermined value, which time average is the average over a switching period comprising the primary stroke period (tₚᵣᵢₘ), the secondary stroke period (t_{sec}), and the off-time period (t_{off}).

2. An electrical converter (1) as claimed in claim 1, wherein the first time control device (44) comprises means for ending the primary stroke period (tₚᵣᵢₘ) when the current flowing to the electrical energy storage device (2) is equal to the predetermined maximum current (Iₘₐₓ).

3. An electrical converter (1) as claimed in claim 1, wherein the second time control device (40) comprises means for ending the off-time period (t_{off}) when the average current flowing to the electrical energy storage device (2) during a switching period equals the predetermined value.

4. An electrical converter (1) as claimed in claim 3, wherein said second time control device (40) comprises:
a first on-off period control device (41) for determining an on-time period (tₒₙ) corresponding to a desired time of the primary and secondary stroke (tₚᵣᵢₘ,t_{sec}) of the electrical energy storage device (2) and an off-period corresponding to a desired off-time period (t_{off}) of the electrical energy storage device (2), which first on-off period control device (41) has an output for outputting an off-time end signal, which output is communicatively connected to a control of the electrical energy storage device (2).

5. An electrical converter (1) as claimed in claim 4, wherein the first on-off period control device (41) comprises:
a first capacitor (413) connected to a first current source (412) in an interruptable loop (412-414), which interruptable loop (412-414) is further connected to a second current source (411) and,
an interrupter (414) for interrupting said interruptable loop when the sensed current is equal to the predetermined maximum current (Iₘₐₓ) and for closing the interruptable loop when the current sensed by the current sensing device is substantially zero.

6. An electrical converter (1) as claimed in claim 4, wherein the second time control device (40) further comprises:
a second on-off period control device (42) communicatively connected to the output of the first on-off period control device (41) for determining a second off-period corresponding to a desired combined time of the secondary stroke period (t_{sec}) and the off-time period (t_{off}), which second on-off period control device (42) is arranged for generating a start signal (strt tₚᵣᵢₘ) for starting the primary stroke period (tₚᵣᵢₘ) at an end of the second off-period.

7. An electrical converter as claimed in claim 6, wherein the second on-off period control device (42) comprises:
a voltage to current converter (421) having a current output for outputting at the current output a current corresponding to the voltage (V₄₁₃) across the first capacitor (413), which voltage to current converter (421) is connected to the first capacitor (413) and,
a second capacitor (422) connected with a contact to the current output, which contact is also connected to a comparator device (43) for comparing a capacitor voltage (V₄₂₂) across the second capacitor (422) with a trigger voltage (Vₜᵣ) and outputting the start signal if the trigger voltage (Vₜᵣ) is below the capacitor voltage, and
a discharging device (423) for discharging the second capacitor in response to the start signal.

8. An electrical converter (1) as claimed in claim 1, further comprising at least one switch (3) which, when in a conducting state, establishes an electrical contact between the storage input and the at least one converter input (IN1,IN2) so as to store electrical energy in the electrical energy storage device (2) and when in a non-conducting state, interrupts the electrical contact of the electrical energy storage device (2) with the converter input (IN1,IN2) so as to release electrical energy from the electrical energy storage device (2) to the converter output (OUT1,OUT2), which switch (3) is controlled by said control device (4).

9. An electrical converter (1) as claimed in claim 1, wherein the current sensing device (5), the switch (3), and the electrical energy storage device (2) are connected in series between a first converter input (IN1) and a first converter output (OUT1), and a node (32) between the switch (3) and the electrical energy storage device (2) is connected to a second converter input (IN2) with a unidirectional conducting device (6).

10. An electrical converter (1) as claimed in claim 1, wherein the predetermined maximum current (Iₘₐₓ) is lower than or equal to the saturation current of the electrical energy storage device (2).

11. An electrical appliance (SVR) comprising: a rechargeable battery (B), an electric motor (M), a switch (SW) for connecting the motor (M) to the battery (B), and an electrical converter device as claimed in claim 1 for charging the battery (B) and/or powering the motor (M).
